(19) United States
(12) Patent Application Publication
(10) Pub. No.: US 2026/0128297 A1
(43) Pub. Date: May 7, 2026

(54) ELECTROCATALYSTS ON CARBON CLOTH SYNTHESIZED BY ELECTRODEPOSITION METHOD

(71) Applicant: UNM RAINFOREST INNOVATIONS, Albuquerque, NM (US)

(72) Inventors: Jianda WANG, Albuquerque, NM (US); Shuya WEI, Albuquerque, NM (US)

(73) Assignee: UNM RAINFOREST INNOVATIONS, Albuquerque, NM (US)

(21) Appl. No.: 19/381,516

(22) Filed: Nov. 6, 2025

Related U.S. Application Data
(60) Provisional application No. 63/717,437, filed on Nov. 7, 2024.

(51) Int. Cl. H01M 4/505; H01M 4/02; H01M 4/04; H01M 4/66; H01M 10/052

(52) U.S. Cl. CPC H01M 4/505; H01M 4/0404; H01M 4/045; H01M 4/663; H01M 10/052; H01M 2004/021

(57) ABSTRACT

An electrode for a lithium-carbon dioxide battery is disclosed, as well as a method to synthesize an electrode for a lithium-carbon dioxide battery. The electrode includes an electrocatalyst which may include a manganese-based transition metal oxide, where the electrocatalyst is supported by a carbon cloth. The electrocatalyst is nanostructured, in the form of a nanosheet, and the manganese-based transition metal oxide has a chemical formula of AMn₂O₄, in which A is selected from nickel, zinc, or cobalt. The electrocatalyst has a dimension of from about 1 nm to about 100 nm. The electrocatalyst may include a crystal structure including a spinel phase. Methods include preparing a metal hydroxide precursor having a manganese-based transition metal oxide, precipitating the metal hydroxide precursor onto a carbon cloth, calcinating the metal hydroxide precursor onto the carbon cloth, and forming a manganese-based transition metal electrode for a lithium-carbon dioxide battery.

### REFERENCE TO RELATED APPLICATIONS

This application claims the benefit of U.S. Provisional Patent Application No. 63/717,437, filed on Nov. 7, 2024, which is hereby incorporated by reference in its entirety.

### STATEMENT OF GOVERNMENT INTEREST

This invention was made with government support under grant number 2119688 awarded by the National Science Foundation. The government has certain rights in the invention.

### TECHNICAL FIELD

The present teachings relate generally to electrocatalysts for rechargeable batteries and, more particularly, to rechargeable batteries incorporating manganese-based transition metal oxides.

### BACKGROUND

One challenge in contemporary society is the greenhouse effect resulting from elevated atmospheric CO₂ levels. Consequently, it is a necessary requirement to develop high-efficiency and cost-effective technologies to reduce CO₂ concentrations. For example, chemical adsorption methods based on amine or alkaline solutions are reported to capture and fix CO₂. However, their high cost and low efficiency pose significant barriers to large-scale applications. Fortunately, lithium-carbon dioxide (Li—CO₂) batteries have become a promising technology to capture and convert CO₂. Additionally, Li—CO₂ batteries are regarded as excellent energy conversion devices, capable of supplying electrical energy to help alleviate the problem of energy shortages.

Rechargeable Li—CO₂ batteries face challenges of sluggish reaction kinetic and poor rechargeability. Highly efficient electrocatalysts are urgently needed to decompose the discharge product, Li₂CO₃. Transition metal oxides are regarded as promising candidates for improving cycle performance and reaction kinetic of Li—CO₂ batteries. Notably, morphology engineering plays a vital role in enhancing electrocatalytic performance by tuning the structure of the electrode.

The morphology of battery electrode materials can influence their electrochemical performance by shaping how ions and electrons move and react. Nanostructured and porous morphologies can provide increased surface area and active sites, accelerating reaction rates and improving battery capacity. By directing specific crystal facets and controlling defects reaction pathways and lower overpotentials can be fine-tuned, while interconnected structures enhance electrical conductivity. Some morphologies, such as nanowires or nanoplates designs, maintain structural integrity during cycling. A combination of these factors can optimize charge transfer, ion transport, and durability, resulting in more efficient and longer-lasting batteries.

Therefore, it is desirable to develop improved electrocatalytic performance of transition metal-based transition metal oxides via morphology engineering, and also demonstrate a general selection principle for next-generation electrocatalysts for metal-CO₂ batteries.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An electrode for a lithium-carbon dioxide battery is disclosed. The electrode includes an electrocatalyst which may include a manganese-based transition metal oxide, and where the electrocatalyst is supported by a carbon cloth. Implementations of the electrode can include where the electrocatalyst is nanostructured. The manganese-based transition metal oxide has a chemical formula of AMn₂O₄, in which A is selected from nickel, zinc, or cobalt. The electrocatalyst has a dimension of from about 1 nm to about 100 nm. The electrocatalyst is in the form of a nanosheet. The lithium-carbon dioxide battery has a discharge capacity of 12,274 mAh/g. The electrocatalyst may include a crystal structure including a spinel phase.

A method to synthesize an electrode for a lithium-carbon dioxide battery is disclosed. The method to synthesize an electrode for a lithium-carbon dioxide battery includes preparing a metal hydroxide precursor having a manganese-based transition metal oxide, precipitating the metal hydroxide precursor onto a carbon cloth, calcinating the metal hydroxide precursor onto the carbon cloth, and forming a manganese-based transition metal electrode for a lithium-carbon dioxide battery. Implementations of the method to synthesize an electrode for a lithium-carbon dioxide battery can include where the metal hydroxide precursor has a chemical formula of AMn₂O₄, where A is selected from nickel, zinc, or cobalt. The metal hydroxide precursor is precipitated onto the carbon cloth using an electrodeposition method. Calcinating the metal hydroxide may include exposing the metal hydroxide precursor to a temperature above 400° C. The metal hydroxide precursor may include Mn₂(OH)₄. Preparing the metal hydroxide precursor may include forming the metal hydroxide precursor by combining ANO₃ and Mn₂O₃. The electrode may include a manganese-based transition metal electrocatalyst in the form of a nanosheet. The manganese-based transition metal electrocatalyst may include a crystal structure that includes a spinel phase.

Another lithium-carbon dioxide battery is disclosed. The lithium-carbon dioxide battery includes at least one electrode having an electrocatalyst supported by a carbon cloth, and where the electrocatalyst includes a manganese-based transition metal oxide. Implementations of the lithium-carbon dioxide battery can include where the electrocatalyst has a nanostructure. The manganese-based transition metal oxide has a chemical formula of AMn₂O₄, in which A is selected from nickel, zinc, or cobalt. The electrocatalyst has a dimension of from about 1 nm to about 100 nm. The electrocatalyst is in the form of a nanosheet.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A-1J depict a schematic of the synthesis process of manganese-based electrocatalysts and several high-resolution transmission electron microscopy (HRTEM) images and scanning electron microscope (SEM) images of these electrocatalysts, respectively, in accordance with the present disclosure.

FIGS. 2A-2D are X-ray photoelectron spectroscopy (XPS) survey scan spectra of NMO electrocatalysts, Mn 2p spectrum, Ni 2p spectrum and O 1s spectrum, respectively, in accordance with the present disclosure.

FIGS. 3A-3F are plots showing electrochemical performance of AMn₂O₄@carbon cloth. FIGS. 3A and 3D are galvanostatic curves and terminal discharge voltage profiles for Li—CO₂ batteries with NMO electrocatalysts, FIGS. 3B and 3E are galvanostatic curves and terminal discharge voltage profiles for Li—CO₂ batteries with ZMO electrocatalysts, and FIGS. 3C and 3F are galvanostatic curves and terminal discharge voltage profiles for Li—CO₂ batteries with CMO electrocatalysts, in accordance with the present disclosure.

FIGS. 4A-4D are CV curves of Li—CO₂ batteries with different cathode (NMO@CC, ZMO@CC, CMO@CC and CC), a plot showing differences between the overpotential of NMO@CC, ZMO@CC and CMO@CC at different rates, discharging-charging profiles of Li—CO₂ batteries with NMO@CC cathode, and a plot showing the difference of discharging-charging profiles of Li—CO₂ batteries with pure carbon cloth and NMO@CC, respectively, in accordance with the present disclosure.

FIGS. 5A-5F are HRTEM image of Li₂CO₃, XPS results of Li is of electrode at discharged state and recharged state, Raman spectra of discharged and charged electrode, and XPS results of C is of electrode discharged state and recharged state, respectively, in accordance with the present disclosure.

FIG. 6 is a schematic of a working Li—CO₂ batteries highlighting the role of electrocatalysts as described herein, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

A nanostructured Mn-based electrocatalysts with high surface area and rich active sites was developed. Some of the electrocatalysts are manganese-based transition metal electrocatalysts. A nanostructured material can be defined as a material having a physical structure or morphology on the nanoscale, characterized by dimensions of from about 1 nanometer to about 100 nanometers. The nanostructured electrocatalysts were synthesized using a facile anodic electrodeposition method by depositing Mn-based hydroxides directly on to a carbon cloth electrode, followed by a calcination process. Calcination includes exposing a material to an elevated temperature to cause a controlled thermal decomposition, remove water or carbon dioxide, or alter the physical or chemical properties of the material. The electrochemical characterization showed that a lithium-carbon dioxide (Li—CO₂) battery with Mn-based transition metal oxides AMn₂O₄ (A=Ni, Zn, Co) achieves impressive cycle performance (over 250 cycles at 100 mA/g). This work not only exhibits the excellent electrocatalytic performance of manganese-based transition metal oxide, but also demonstrates a general selection principle for next-generation electrocatalysts for metal-CO₂ battery. These manganese-based transition metal electrodes enable and contribute to the improved performance of lithium-carbon dioxide batteries employing these electrodes in their construction.

In examples of the present disclosure, it should be noted that the terminology of NMO@CC, ZMO@CC, CMO@CC, AMn₂O₄@carbon cloth, and CC, for example, refers to an abbreviation for “deposited onto carbon cloth (CC),” and is used as a shorthand for the construction of electrodes as described herein. The “@” notation indicates that the AMn₂O₄ (metal oxide) is supported by the carbon cloth substrate. It should also be understood by one skilled in the art that other electrocatalyst examples preceding the “@” designation are not necessarily limited to (nickel manganese oxide (NMO), zinc manganese oxide (ZMO), or cobalt manganese oxide (CMO).

One challenge in contemporary society is the greenhouse effect resulting from elevated atmospheric CO₂ levels. Consequently, it is a necessary requirement to develop high-efficiency and cost-effective technologies to reduce CO₂ concentrations. For example, chemical adsorption methods based on amine or alkaline solutions are reported to capture and fix CO₂. However, their high cost and low efficiency pose significant barriers to large-scale applications. Fortunately, Li—CO₂ batteries have become a promising technology to capture CO₂ and convert it into valuable products. Additionally, Li—CO₂ batteries are regarded as excellent energy conversion devices, capable of supplying electrical energy to help alleviate the problem of energy shortages.

The common reversible reaction of Li—CO₂ batteries (4Li+3CO₂⇔2Li₂CO₃+C) shows that Li⁺ ions react with soluble CO₂ to form discharged products, continuously producing electricity during the discharge process. The recharging process involves decomposing Li₂CO₃ and releasing CO₂, with Li⁺ ions returning back to the anode side. Rechargeable Li—CO₂ batteries with high theoretical capacity (1876 mAh/g) are attractive as a next-generation energy storage system. However, the discharged product Li₂CO₃ is thermodynamically stable and difficult to decompose, which increases overpotential and decreases the reversibility of rechargeable Li—CO₂ batteries. Developing suitable electrocatalysts to facilitate reaction kinetic and enhance cycled ability is the major task. Recently, Mn-based transition metal oxides become promising candidate as electrocatalysts for Li—CO₂ batteries. Their impressive catalytic performance and low cost endow Mn-based electrocatalysts with the ability to decompose Li₂CO₃ effectively, improving electrochemical performance. In addition, mixed transition metal oxides show superior catalytical performance than single transition metal oxide, likely due to the additional redox active sites provided by mixed transition metal oxides. Notably, morphology engineering can act as a useful strategy to promote electrocatalytic performance of electrocatalysts. Elaborated surface morphology and unique structure, such as nanostructures, can effectively enhance reactivity and lifetime of electrocatalysts.

In the present disclosure, a series of Mn-based transition metal oxide electrocatalysts using nickel, zinc, and cobalt, having the formula AMn₂O₄ (AMO, A=Ni, Zn, and Co) with a nanosheet structure were designed and developed through anode electrodeposition and calcination process. Mn-based electrocatalysts supported by carbon cloth (CC) with a unique three-dimensional (3D) architecture provide high surface area and abundant active sites. Li—CO₂ batteries with nanostructured Mn-based electrocatalysts have a longer cycle performance and lower overpotential compared with its bulk counterpart. Notably, Li—CO₂ batteries with the NiMn₂O₄@CC (NMO@CC) composite electrode exhibited a high discharge capacity of 12,274 mAh/g and excellent cycling performance, achieving 272 cycles at a charge voltage below 4.3 V. The improved electrochemical performance can be attributed to the unique structure and excellent catalytic ability Mn-based transition metal oxide. Ex-situ spectroscopic and microscopic characterizations were conducted to elucidate the electrochemical reaction mechanism and the role of Mn-based electrocatalysts. Additional transition metals aside from Ni, Zn, and Co can be applicable to the electrocatalysts as described herein. Particularly, A in AMn₂O₄ electrocatalysts could be replaced by another transition metal, such as Fe, Co, Cu, Cr, V, Ti, Mo to form a spinel-type metal oxide. In examples of the present teachings, the individual nanosheets of Mn-based transition metal oxides possess a thickness of about 60-80 nm, with lateral dimensions ranging from 0.5 to 5 μm. The nanosheets are interconnected and interlaced with each other, forming a three-dimensional honeycomb-like porous framework. As a result, Li—CO₂ batteries with the AMO@CC composite electrode exhibits a discharge capacity within a wider range of 8,000 to 16,000 mAh/g, preferably within a medium range of 10,000 to 14,000 mAh/g, and more preferably within a narrow range of 11,000 to 13,000 mAh/g, when tested at a current density of 100 mAh/g. It should be noted that ranges for discharge capacity as shown and described in regard to the figures herein can be understood to be effective ranges for performance of electrochemical devices utilizing the electrocatalysts of the present teachings.

### Results and Discussion

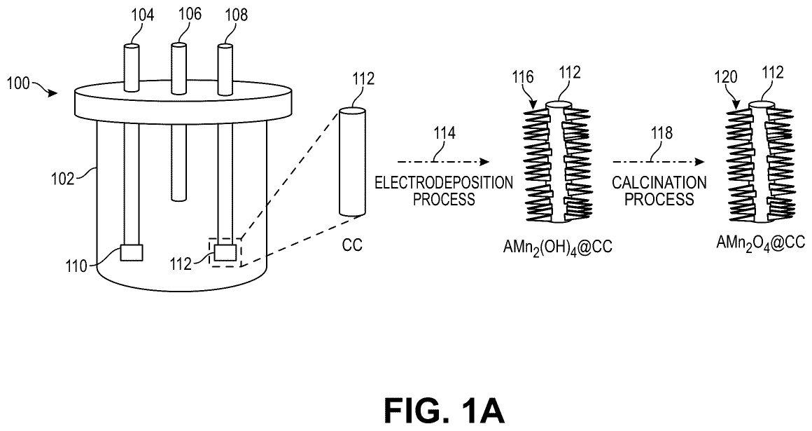

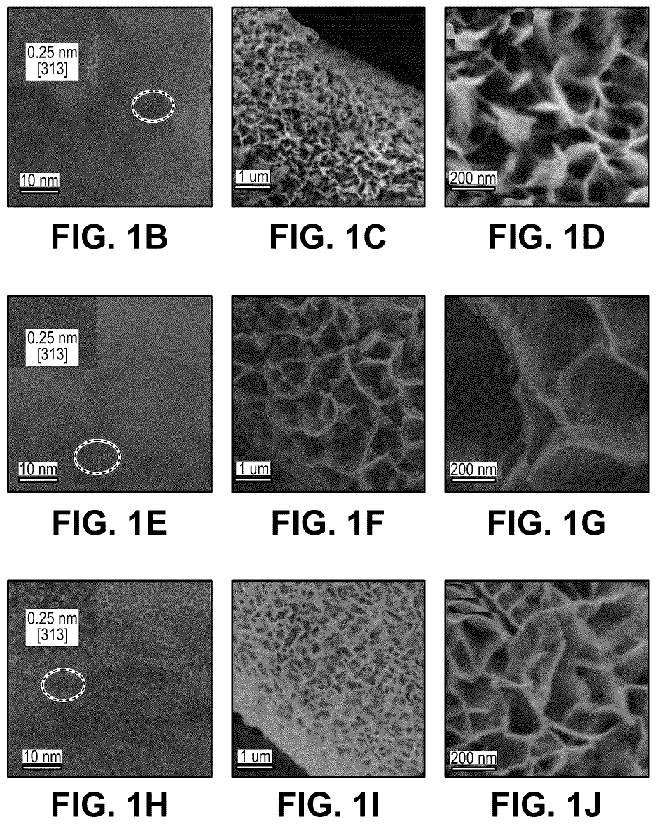

FIGS. 1A-1J depict a schematic of the synthesis process of manganese-based electrocatalysts and several high-resolution transmission electron microscopy (HRTEM) images and scanning electron microscope (SEM) images of these electrocatalysts, respectively, in accordance with the present disclosure.

FIG. 1A shows the synthesis process of Mn-based electrocatalysts. Metal hydroxide precursors of Mn-based transition metal oxides are synthesized by a facile anode electrodeposition 114 method at the first step, the reaction is as follows:

$$\times {A}^{2 +} + 2 \times {Mn}^{2 +} + 6 \times OH = {A}_{x} {{Mn}_{2 x} ( OH )}_{6 x} ( A = Ni , Zn and Co ) \qquad ( 1 )$$

Aqueous metal nitrides containing 0.0005 M of ANO₃ and 0.001 M MnNO₃ are used as electrolytes in reaction vessel 100. Metal hydroxide precursors 102 are directly precipitated on the carbon cloth 112 working electrode 108 for six minutes with a constant voltage of 0.9, 1.0 and 1.5V, respectively. Where OH⁻ comes from the reduction of NO₃⁻ at the side of cathode 104, which includes platinum 110. Also shown is a reference electrode 106. After the electrodeposition 114 process, the metal oxide precursors 116 having the chemical formula of AMn₂(OH)₄ 116 on the carbon cloth 112 are then calcinated using a calcination process 118 at 400 degrees C. to obtain final transition metal oxide products 120. The calcination process was performed under an oxidizing atmosphere (air), without the use of inert or reducing gases. The applicable temperature ranges for calcination include a wide range of 300-500° C., a medium range of 350-450° C., and a narrow range of 390-410° C., and proceeds according to the following reaction scheme:

$$0.5 \times {O}_{2} + {A}_{x} {{Mn}_{2 x} ( OH )}_{6 x} = \times {AMn}_{2} {O}_{4} + 3 \times H 2 O \qquad ( 2 )$$

As a result, a series of Mn-based transition metal oxides 120 are synthesized on the surface of carbon cloth 112, shown on the working electrode 108 as well as in an enlarged view. High-resolution transmission electron microscopy (HRTEM) and scanning electron microscope (SEM) images of NiMn₂O₄ (NMO), ZnMn₂O₄ (ZMO), and CoMn₂O₄ (CMO) are shown. FIGS. 1B, 1E and 1H exhibit d-spacings of 0.25, 0.27 and 0.25 nm, which can be indexed as the (311), (103) and (211) plane for NMO, ZMO, and CMO respectively. In addition, the (211) plane of ZMO can also be identified by d-pacing of lattice space of 0.25 nm. Also shown are SEM images of NMO, ZMO, and CMO. As shown in FIGS. 1C, 1F, and 1I, NMO, ZMO, and CMO grown on carbon cloth substrate uniformly, and thickness of nanosheets featuring smooth surface area is around 60 nm (FIGS. 1D, 1G, and 1J), where high surface area can provide abundant active sites for CO₂ reduction reaction (CO₂RR) and CO₂ evolution reaction (CO₂ER) process. Notably, it can be only observed the existence of pores in surface of NMO electrocatalysts, which could further improve surface area and facilitate CO₂ diffusion. Additional scanning transmission electron microscopy (STEM) images have also exhibited the ultrathin nanosheet structure of the transition metal oxide NMO, and the energy-dispersive X-ray spectroscopy (EDS) mapping of NMO exhibits the homogenous distribution of Ni, Mn and O elements. The carbon cloth possesses a woven fibrous structure composed of interlaced carbon fibers, forming a flexible and conductive network. It primarily serves as a mechanically stable and electrically conductive substrate for the growth of metal oxides. In examples, the reactions to obtain final transition metal oxide products can be conducted from about 200° C. to about 500° C., or from about 300° C. to about 500° C., or from about 300° C. to about 400° C., or any temperature within these ranges.

X-ray diffraction (XRD) technology was performed to investigate the crystal structure of NMO, ZMO, and CMO electrocatalysts produced as described herein. The as-prepared Mn-based electrocatalysts corresponded well with spinel phase. Spinel phase refers to a specific arrangement of atoms in a spinel structure, which is a particular cubic crystal system. The characteristic peaks of NMO can be observed, with peaks at 2θ value of 35.5° and 53.2° respectively indexed to the (311) and (422) planes. The peaks of ZMO could be indexed to (103), (211) and (312) at 2θ value of 33.4, 36.5 and 53.6, while the peaks of CMO could be indexed to (211), (312) and (400) at 2θ value of 36.6, 53.4 and 64.7.

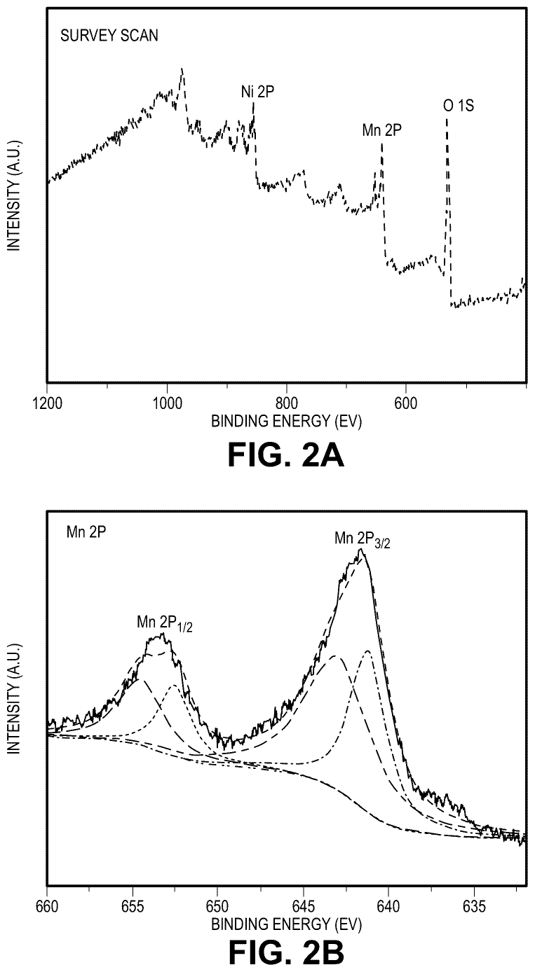

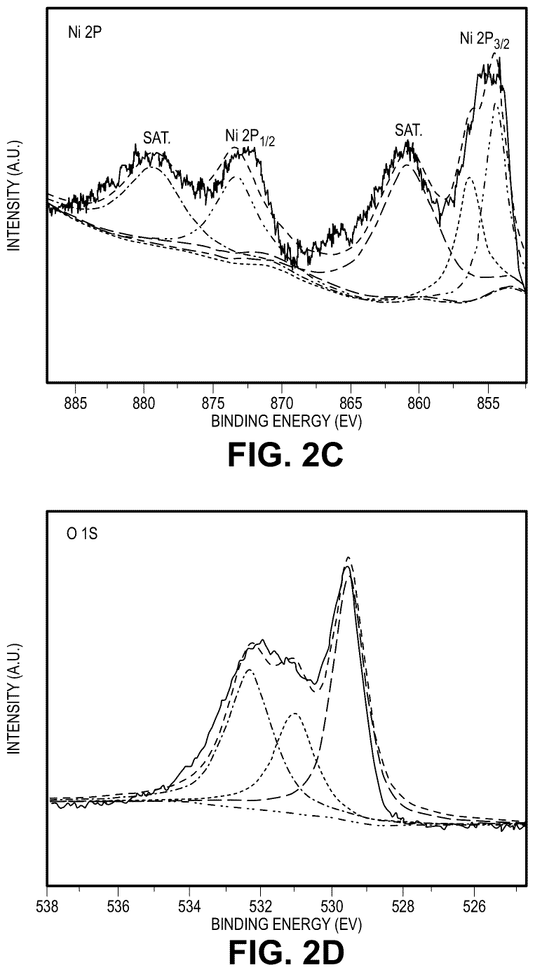

FIGS. 2A-2D are X-ray photoelectron spectroscopy (XPS) survey scan spectra of NMO electrocatalysts, Mn 2p spectrum, Ni 2p spectrum and O 1s spectrum, respectively, in accordance with the present disclosure. XPS technology was performed to study the elemental composition and oxidation state of NMO electrocatalysts produced as shown in (FIGS. 2A-2D. Ni, Mn and O elements can be found from full survey spectra of NMO shown in FIG. 2A. FIGS. 2B and 2D exhibit the high-resolution spectra of Mn 2p, Ni 2p as well as O 1s regions, respectively. FIG. 2B shows the high-resolution XPS data of Mn 2p: Mn 2p_{3/2} and Mn 2p_{1/2}. The four peaks in FIG. 2B come from the deconvolution of two spin-orbit peaks in the Mn spectra. Two deconvolved peaks located at 641.3 and 643.1 eV can be indexed to Mn 2p_{3/2}, and two deconvolved peaks found at 652.4 eV and 654.6 could be assigned to Mn 2p_{1/2}. The set of peaks at 641.3 and 652.4 eV are correspond to correlative peaks of Mn²⁺, while another set of peaks at 642.5 and 654.0 eV means the presence of Mn³⁺. These data confirmed coexistence of Mn²⁺/Mn³⁺ in NMO. FIG. 2C shows the high-resolution spectra of Ni 2p: Ni 2p_{1/2} and Ni 2p_{3/2}. Two typical peaks at 854.5 and 856.4 eV can act as evidence for formation of Ni 2p_{3/2}, while two peaks located at 871.6 and 873.4 eV are caused by Ni 2p_{1/2}. Characteristic peaks at 860.8 and 879.4 eV can be assigned to satellite peaks of the Ni 2p_{1/2} and Ni 2p_{3/2}, corresponding to previous published literature. These results clearly revealed the coexistence of Ni²⁺ (856.4/873.4 eV) and Ni³⁺ (854.5/871.6 eV) in NMO. The high-resolution XPS data of O 1s is shown in FIG. 2D. The representative peak for O 1 s at 529.4 eV can be assigned to metal and oxygen bonds M-O-M, and the peak at 530.8 eV is matched with oxygen vacancies. In addition, the typical peak at 532.2 eV can uncover existence of defect sites with a low oxygen coordination.

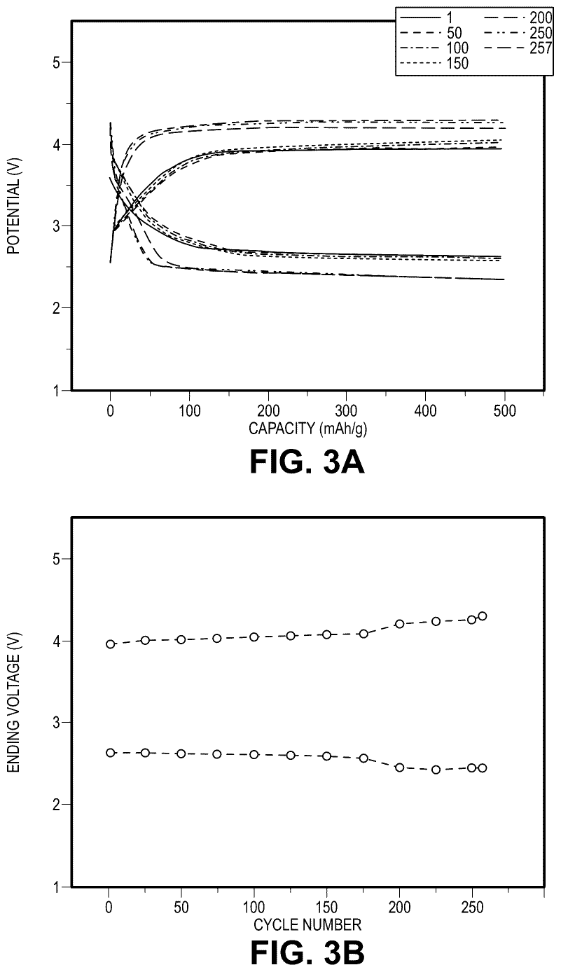

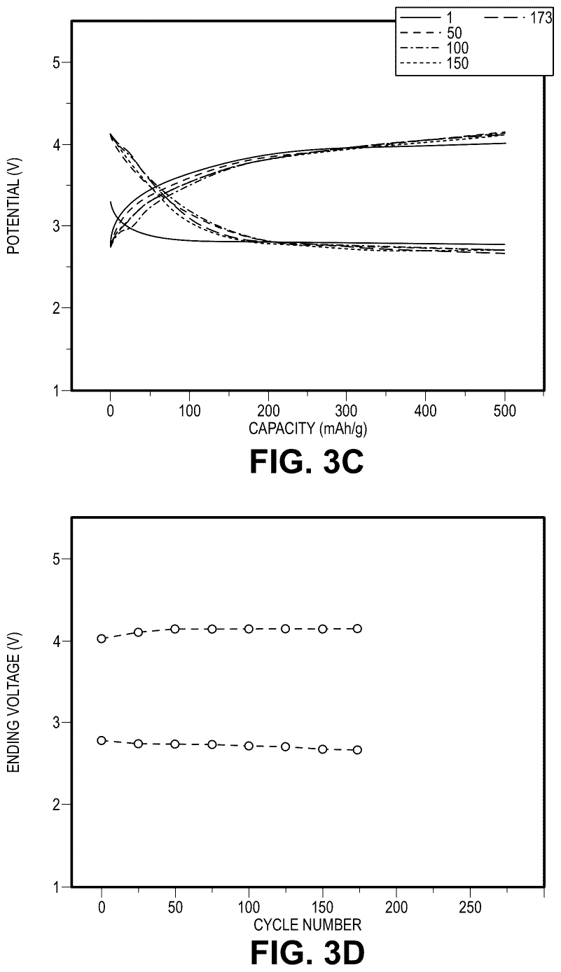

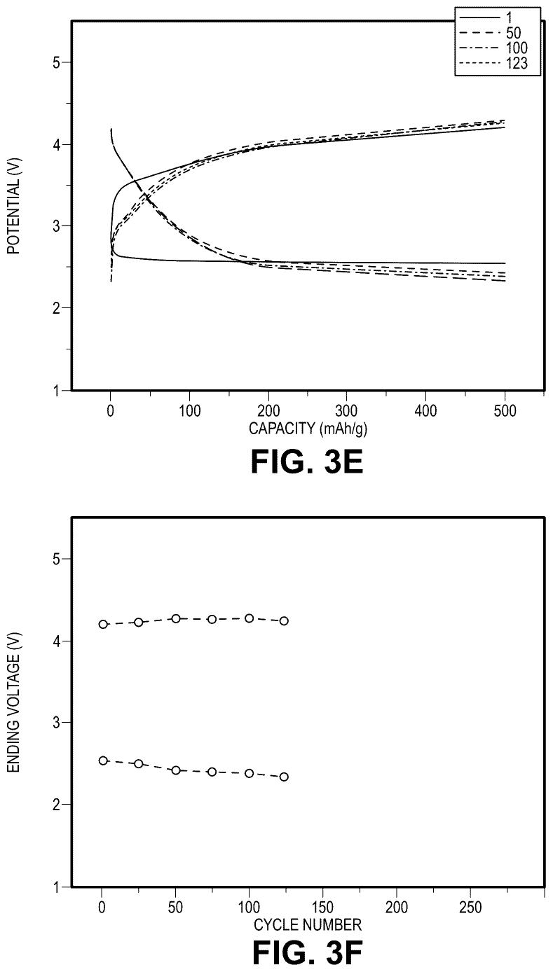

FIGS. 3A-3F are plots showing electrochemical performance of AMn₂O₄@carbon cloth FIGS. 3A and 3D are galvanostatic curves and terminal discharge voltage profiles for Li—CO₂ batteries with NMO electrocatalysts, FIGS. 3B and 3E are galvanostatic curves and terminal discharge voltage profiles for Li—CO₂ batteries with ZMO electrocatalysts, and FIGS. 3C and 3F are galvanostatic curves and terminal discharge voltage profiles for Li—CO₂ batteries with CMO electrocatalysts, in accordance with the present disclosure.

To explore the effect of Mn-based transition metal oxides on the catalytic activity of CO₂RR and CO₂ER process, cycle performances of Li—CO₂ batteries in different cathodes were studied. Linear sweep voltammetry (LSV) was tested to investigate stability of electrolyte. The cycling stability of the Li—CO₂ batteries with the NMO@CC, ZMO@CC and CMO@CC electrodes was studied under continuous discharge/charge stages at a current density of 100 mA/g with a cutoff capacity of 500 mAh/g, as shown in FIGS. 3A-3F. As shown in FIG. 3A, the Li—CO₂ battery using the NMO@CC cathode can be stably discharged and charged over 200 cycles. The discharge voltage plateau of the Li—CO₂ battery using the NMO@CC cathode is at 2.69 V, which also has the lowest overpotential of 1.30 V between charge and discharge. Increasing overpotential is caused by accumulation of discharged product with cycles increase.

In addition, consumption of CO₂ and degradation of electrolyte also further limit CO₂ reduction reaction and CO₂ evolution reaction. In known comparisons of electrochemical properties of Li—CO₂ batteries comparison shows that the electrochemical performances of Li-CO₂ battery with NMO@CC cathode are better than that of most reported Li—CO₂ batteries, with improvements in both overpotential and cycle ability. For example, cycle performance of Li—CO₂ batteries with other transition metal oxide NiO and Mn₂O₃ can only achieve 45 and 55 cycles, respectively. In addition, low overpotential (1.3 V) and impressive cycled ability (272 cycles) of NMO@CC is superior to some noble metal oxide, indicating ability of this type of electrocatalysts for large-scale application. All these results indicate that nanosheet-structured NMO is a promising cathode catalyst for enabling high performance and long cycle life of Li—CO₂ batteries. In addition, Li—CO₂ batteries with ZMO@CC and CMO@CC cathode shown in FIGS. 3B and 3C achieve 170 and 123 cycles, which are lower than NMO@CC cathode. Compared with previously known results with microstructured NMO catalyst, Li—CO₂ batteries with nanosheet-structured transition metal oxide can achieve higher cycle stability and lower overpotential, suggesting rich active sites provided by nanostructured electrocatalysts.

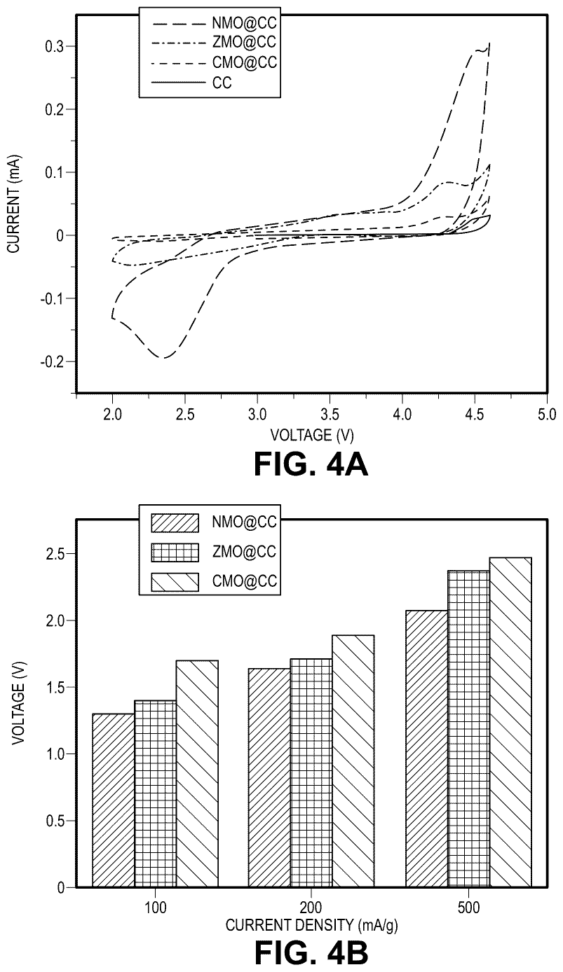

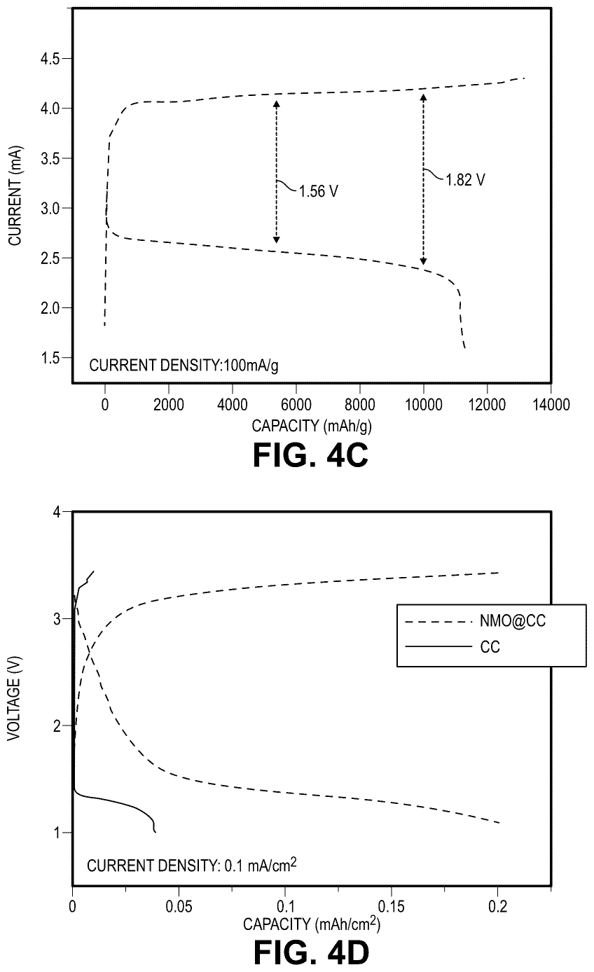

FIGS. 4A-4D are CV curves of Li—CO₂ batteries with different cathode (NMO@CC, ZMO@CC, CMO@CC and CC), a plot showing differences between the overpotential of NMO@CC, ZMO@CC and CMO@CC at different rates, discharging-charging profiles of Li—CO₂ batteries with NMO@CC cathode, and a plot showing the difference of discharging-charging profiles of Li—CO₂ batteries with pure carbon cloth and NMO@CC, respectively, in accordance with the present disclosure.

Cyclic voltammetry (CV) for Li—CO₂ batteries was preformed with different electrocatalysts (NMO, ZMO, CMO) in the range from 2 to 4.6 V at a scan rate of 0.1 mV/s (FIG. 4A). The CV profile of Li—CO₂ batteries with pure carbon cloth is also investigated as comparison for Mn-based electrocatalysts. The results clearly show that Li—CO₂ batteries with NMO@CC cathode have the highest anodic and cathodic peaks (2.43 V and 4.06 V), suggesting the ability of NMO to effectively improve reaction kinetics of CO₂RR and CO₂ER for Li—CO₂ batteries. CV profiles of cathode ZMO@CC and CMO@CC also have more obvious cathodic peaks compared with pure carbon cloth. These results demonstrate promotional effect of Mn-based nanostructured electrocatalysts to enhance charging process, which is consistent with the improved cycle performance. Additionally, CV profiles over different cycles have been studied with scan rate of 0.1 mV/s to understand the reversibility of the Li—CO₂ battery with the NMO@CC cathode. FIG. 4B exhibits the relationship between overpotential and current density of the Li—CO₂ batteries with different catalysts varying from 100 mA/g to 500 mA/g (limited capacity: 500 mAh/g). The overpotential of NMO@CC, ZMO@CC and CMO@CC were 1.30, 1.43 and 1.68 V at 100 mA/g; 1.64, 1.71 and 1.85 V at 200 mA/g; 2.07, 2.37 and 2.48 V at 500 mA/g, respectively. Notably, the overpotential of Li—CO₂ batteries with NMO electrocatalyst is smaller than those of the batteries with ZMO and CMO electrocatalysts, suggesting the potential of the NMO@CC cathode for scaling up to practical applications. Further, to evaluate the long-term charging-discharging ability of NMO@CC cathode, the galvanostatic charge-discharge testing at current density of 100 mA/g (FIG. 4C) was conducted. The results showed that Li-CO₂ battery with NMO@CC cathode achieved an impressive charging capacity (13068 mAh/g) and discharging capacity (11274 mAh/g), and overpotential of the Li—CO₂ battery were 1.56 and 1.82 V at 5000 mAh/g and 10000 mAh/g, respectively. Li—CO₂ battery with NMO@CC cathode have a significant improvement in discharging and charging ability compared with pure CC (FIG. 4D). The reason can contribute to NMO electrocatalysts play a crucial role in promoting reaction kinetics during the charging and discharging process. The above data further imply impressive bidirectional electrocatalytic activity of Mn-based nanostructured electrocatalysts for both CO₂RR and CO₂ER processes, the electrocatalytic ability can improve energy efficiency and enhance reversible conversion reaction of Li—CO₂ batteries.

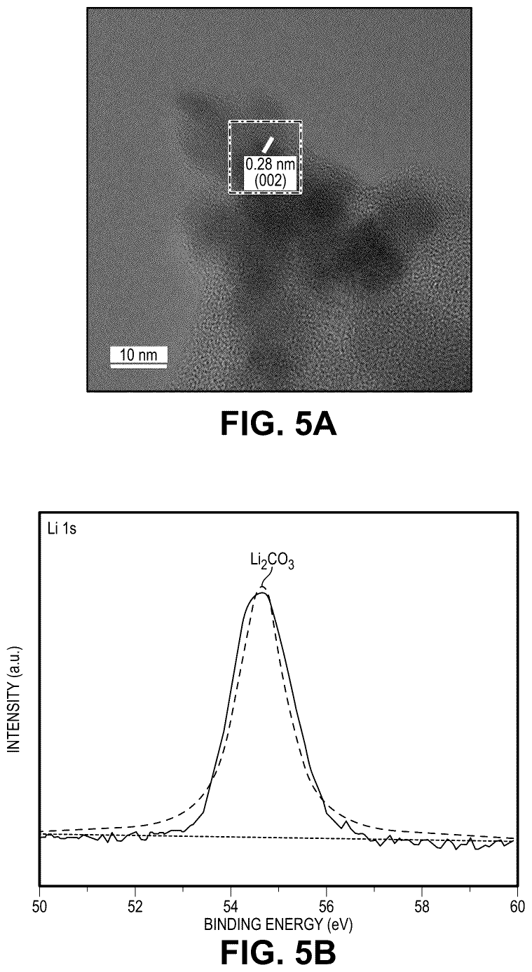

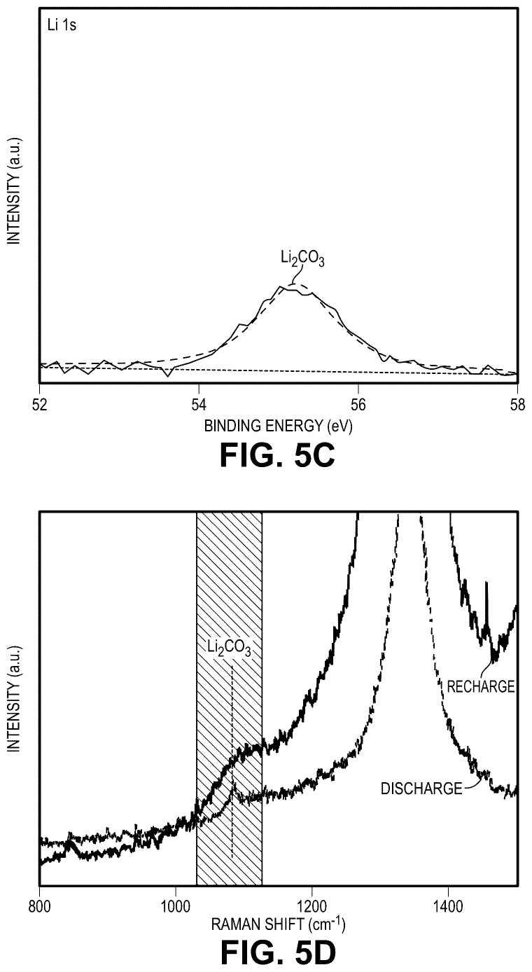

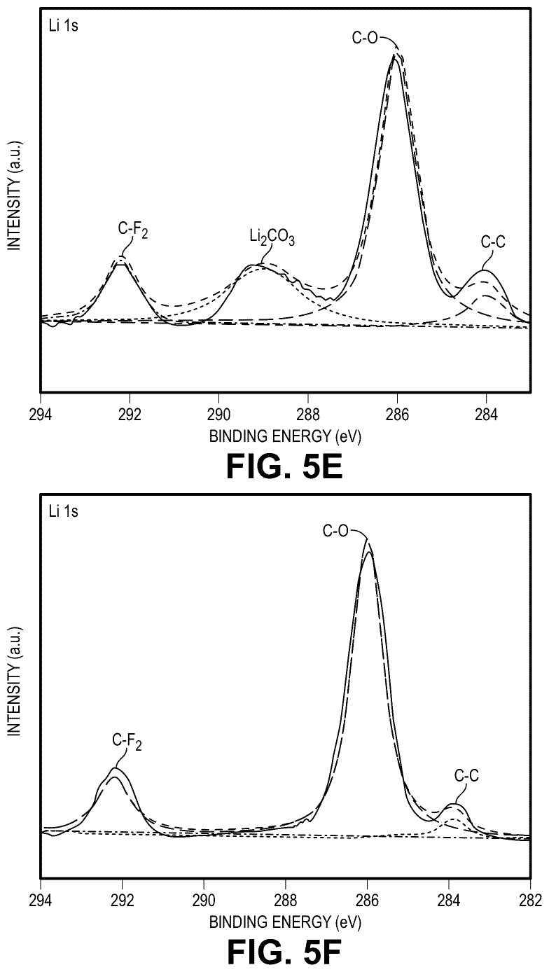

FIGS. 5A-5F are HRTEM image of Li₂CO₃, XPS results of Li is of electrode at discharged state and recharged state, Raman spectra of discharged and charged electrode, and XPS results of C is of electrode discharged state and recharged state, respectively, in accordance with the present disclosure.

Li—CO₂ batteries with the NMO@CC cathode are selected as an example to further understand the mechanism and role of Mn-based electrocatalysts to improve electrochemical properties. Ex situ XPS, Raman, XRD and high-resolution transmission electron microscopy (HRTEM) technologies were performed to further study the reaction mechanism of Li—CO₂ batteries and to identify chemical compositions of the discharged product. Discharged and recharged electrode were obtained from the first discharging and recharging process of Li—CO₂ batteries at a current density of 100 mA/g and a limited capacity of 500 mAh/g. The HRTEM image of the discharged electrode, shown in FIG. 5A, reveals the composition of discharged products. A typical lattice space with 0.28 nm can be indexed as the (002) plane of Li₂CO₃.⁴¹ XPS characterization method was used to identify the change of surface properties for discharged and recharged NMO@CC cathodes. The comparison for high resolution XPS spectrum of the discharged and recharged NMO@CC cathodes are shown in FIGS. 5A-5F. The change of Li is and C is spectra were studied to reveal the formation/decomposition of discharged products. FIG. 5B shows the results display typical peak at 54.7 eV, which is assigned to the presence of the discharge product Li₂CO₃. This peak significantly decreases after the recharging process (FIG. 5C). Weakened C—C peak (284.1 eV) intensity of discharged cathode is resulted by accumulation of discharge product. For C is spectrum, three peaks at 284.1, 286.3 and 292.2 eV matched with the C—C, C—O and CF₂ bonds, respectively.⁴³ These bonds come from supporting materials carbon cloth. Representative peak of Li₂CO₃ (289.2 eV) can be observed in discharged electrode (FIG. 5E), and this peak almost disappeared after recharging process (FIG. 5F). Additional peaks at 21.9° and 30.9° in the discharged electrode, can be assigned to the (110) and (002) plane of Li₂CO₃. Similar results are also identified in Raman spectra. The peak related to Li₂CO₃ at 1085 cm⁻¹ was found in electrode after discharging process, and it disappeared through recharging process. The comparison is shown in FIG. 5D. Therefore, all these characterization results not only identify the chemical composition of discharged product, but also shed light on mechanism of Li—CO₂ batteries, which consistent with equation 1. More importantly, these results show the impressive ability of NMO electrocatalysts as one type of Mn-based transition metal oxide to decompose Li₂CO₃ for Li—CO₂ batteries, revealing the role of Mn-based electrocatalysts in improving cycle performance and lowering overpotential.

SEM and STEM technology have also been conducted to investigate nucleation and decomposition behavior of discharged product Li₂CO₃ in different states, the morphology changes of Li₂CO₃ particles on all AMO@CC (NMO@CC, ZMO@CC, and CMO@CC) can be observed. It can also be observed that after fully discharging process, the Li₂CO₃ particles nucleate and form uniformly on the surface of electrode, and then fade away after the fully recharging process. The morphology of the recharged electrode is close to its pristine state with the help of electrocatalysts, which is consistent with ex situ XPS, XRD and Raman results. In contrast, Li₂CO₃ particles still accumulate on the surface of pure carbon cloth and form a dense layer after recharging process. Notably, the size of Li₂CO₃ particles is in the range from 100 to 300 nm, implying they are more easily degraded during charging process. Additional STEM images have shown Li₂CO₃ particles with small size.

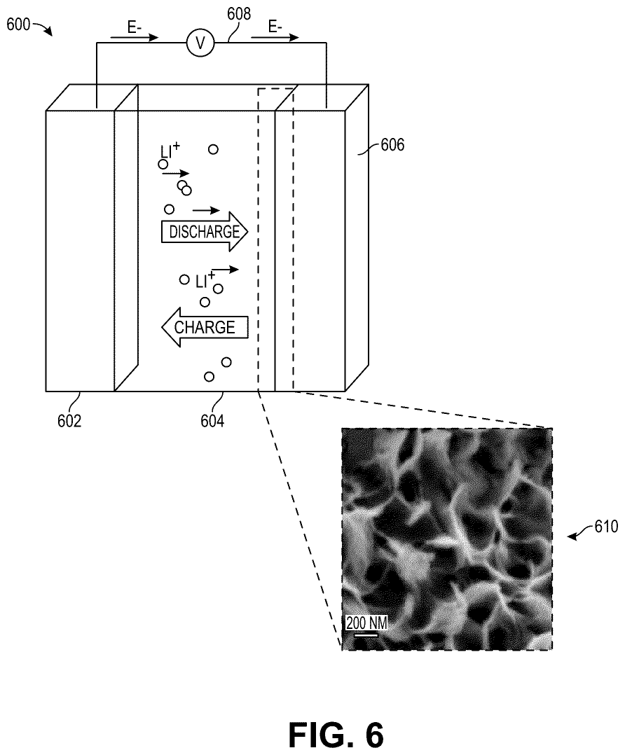

FIG. 6 is a schematic of a working Li—CO₂ batteries highlighting the role of electrocatalysts as described herein, in accordance with the present disclosure. The above-mentioned electrochemical performance of Li—CO₂ batteries clearly shows the advantages of Mn-based transition metal oxide electrocatalysts. Characterization results of electrodes in different states of cycling also reveal the working process of Li—CO₂ batteries with the help of the electrocatalysts. To further uncover the mechanism, FIG. 6 provides the schematic illustration of the working Li—CO₂ batteries 600 and the role of electrocatalysts. As shown in the illustration, Mn-based transition metal oxides on CC act as highly catalytic cathodes 606 in the battery system, which is the key component for Li—CO₂ batteries, while Li foil acts as the anode 602 to provide Li source. During the discharging process, Li⁺ ions from the electrolyte 604 react with CO₂ to produce discharge products Li₂CO₃ and amorphous carbon on the surface of the AMO@CC cathode 606. Meanwhile, electrical energy 608 is continuously produced by the conversion of chemical energy during the reaction. During the recharging process, highly stable Li₂CO3 is easily decomposed with the help of Mn-based electrocatalysts, accompanied by CO₂ release and Li⁺ ions returning to the anode 602 side, consistent with previous characterization data. In additional studies, customized cells were designed to perform the reaction of Li—CO₂ battery 600. They have two channels that allow CO₂ to pass through and chamber can provide place for reaction happen. AMO@CC electrocatalytic cathode plays an essential role in rechargeable Li—CO₂ batteries, and the underlying principle can be attributed to the following reasons:

Firstly, excellent electrical conductivity endows AMO@CC cathode with impressive electrocatalytic performance. Carbon cloth acts as a highly electrically conductive support for Mn-based transition metal oxide electrocatalysts, providing efficient and durable electron transfer. In this way, nanostructured AMO supported by CC with higher electrical conductivity effectively facilitates electron transfer for decomposing discharge products, thereby increasing the reaction kinetics of Li—CO₂ battery. Particularly, NMO has the lowest band gap (0 ev) compared with ZMO (0.77 eV) and CMO (0.7 eV), indicating that NMO electrocatalysts have higher electrical conductivity and better electrocatalytic performance, which is consistent with the electrochemical results showing that Li—CO₂ batteries with NMO@CC have the best performance. Electrochemical impedance spectroscopy (EIS) spectra also shows excellent electronic conductivity of NMO compared with ZMO and CMO.

Secondly, the unique architecture of AMO@CC cathode can promote CO₂ and ion diffusion, strengthening the connection among CO₂, the electrode, and electrolyte, and improve mass transfer at the gas-electrode electrolyte triple-interfaces. More importantly, nanosheet structured AMO electrocatalysts shown in inset image 610 provide a large surface area with rich active sites for decomposing the discharged product Li₂CO₃. During the discharging process, the high surface area effectively avoids accumulation of the discharge products on the surface of the cathode, which is beneficial for improving the cycle ability of Li—CO₂ batteries. Nanostructured AMO has better electrocatalytic ability compared with bulk electrocatalysts. In comparisons of discharging ability of Li—CO₂ batteries between bulk and nanostructured electrocatalysts, it is revealed that Li—CO₂ batteries with nano NMO electrocatalysts have over four times the discharge capacity of bulk NMO at a current density of 100 mA/g. Additionally, the overpotential difference between nano and bulk NMO, shows that Li—CO₂ batteries with bulk and nano NMO have overpotentials of 2.19 V and 1.31 V, respectively. Nano NMO has a much lower overpotential compared with bulk NMO (current density: 100 mA/g, limited capacity: 500 mAh/g). All these results reveal the advantages of nanostructured electrocatalysts in facilitating the CO₂ER and CO₂RR.

Thirdly, high resolution XPS spectrum confirmed the existence of oxygen vacancies (Vo), which promote reaction kinetics of CO₂ adsorption and reduction. On one hand, the existence of Vo modifies the electronic structure of electrocatalysts, improving the adsorption ability for carbon-based species. On the other hand, Vo can decrease the dissociation energy of the C═O bond of CO₂ to reduce the activation energy barrier of CO₂RR.

### CONCLUSION

In summary, nanosheet-structured Mn-based transition metal oxide electrocatalysts supported by carbon cloth (AMO@CC, A=Ni, Zn, and Co), have been developed as advanced electrocatalysts to enhance the electrochemical performance of Li—CO₂ batteries. These AMO electrocatalysts can facilitate the nucleation of Li₂CO₃ during the discharge process and its decomposition during the charge process, thereby boosting the cycle performance and discharging-charging ability of Li—CO₂ battery. Notably, NMO electrocatalysts have outstanding performance in improving cycled ability of Li—CO₂ batteries due to higher electrical conductivity and unique morphology. The methods and devices described in the present disclosure only advances the development of superior Mn-based electrocatalyst but also provides a compelling research direction for designing efficient catalysts for Li—CO₂ batteries, based on a deep understanding of surface morphology in electrocatalysis for CO₂RR and CO₂RE.

### Methods

### Synthesize of AMO@CC (A=Ni, Mn, and Co)

NMO nanosheets on carbon cloth are synthesized by electrodeposition method followed by a calcination process. Firstly, carbon cloths were cleaned with acetone, ethanol, and DI water underwent ultrasonic treatment to eliminate surface contaminants. Then 0.005 mmol Mn(NO₃)₂·6H2O and 0.01 mmol Ni(NO₃)₂·6H₂O were weighed and dissolved in 10 ml DI water, and the solution was continuously stirred for 15 mins. Subsequently, 0.01 mmol NH₄NO₃ was dissolved in 10 ml DI water and added to the metal nitrate solution, followed by an additional 30 mins of stirring to prepare a homogenous electrolyte for electrodeposition process. The electrodeposition process was performed with a three-electrode system. In the setup, platinum wire, Ag/AgCl, and carbon cloth are served as the counter electrode, reference electrode, and working electrode, respectively. The electrodeposition was conducted at constant voltage of −1.0 V (versus Ag/AgCl) for 6 mins to synthesize the precursor of NMO@CC. Then the precursor of NMO@CC will be meticulously rinsed with DI water and ethanol several times. Finally, the sample has a calcination process in air at 400° C. with temperature rate of 1° C./min for 2 hours to obtain final NMO@CC. The synthesis of ZMO@CC and CMO@CC are similar, involving the substitution of nickel nitrate with zinc nitrate and cobalt nitrate, respectively and adjusting the constant voltage to −1.5 V for ZMO@CC and −0.9 V for CMO@CC.

### Materials Characterization

The morphology of the as-prepared samples was characterized by SEM (JEOL JSM-7500FA), and TEM (JEOL 2010). The surface information was obtained by XPS with Kratos AXIS ULTRA X-ray. XRD patterns of the NMO, ZMO, and CMO cathodes were investigated with Rigaku SmartLab X-ray diffractometer. Chemical composition of prepared samples is studied by Raman (WITec Alpha300R). Spectrometer. Electrochemical impedance spectroscopy (EIS) measurements of NMO@CC, ZMO@CC, and CMO@CC cathode were tested by biologic electrochemical potentiate VSP3 at 5 mV AC amplitude and frequencies from 200 kHz to 100 mHz.

### Electrochemical Characterizations

Electrochemical performances were investigated using custom-build Swagelok cells. Before testing, the Swagelok cell was saturated in pure CO₂ for 2 h. During saturation and testing, the CO₂ pressure in the test container was kept at 10 psi. The working electrode was prepared from electrocatalysts supported by carbon cloth. The Swagelok cell was assembled in an argon-filled glovebox. Lithium plate was applied as both the counter electrode and the reference electrode. Glass-fiber filter paper was used as the separator. The electrolyte was 1 M lithium bis(trifluoromethanesulfonyl)imide in tetraethylene glycol dimethyl ether (TEGDME). The galvanostatic curves and cycling performances were collected using a Neware battery testing system. The CV curves were acquired through a PINE electrochemical workstation with a scan rate of 0.1 mV·s⁻¹.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An electrode for a lithium-carbon dioxide battery, comprising:
an electrocatalyst comprising a manganese-based transition metal oxide; and
wherein the electrocatalyst is supported by a carbon cloth.

2. The electrode of claim 1, wherein the electrocatalyst is nanostructured.

3. The electrode of claim 1, wherein the manganese-based transition metal oxide has a chemical formula of AMn₂O₄, in which A is selected from nickel, zinc, or cobalt.

4. The electrode of claim 1, wherein the electrocatalyst has a dimension of from about 1 nm to about 100 nm.

5. The electrode of claim 1, wherein the electrocatalyst is in the form of a nanosheet.

6. The electrode of claim 1, wherein the lithium-carbon dioxide battery has a discharge capacity of from about 8,000 to about 16,000 mAh/g.

7. The electrode of claim 1, wherein the electrocatalyst comprises a crystal structure comprising a spinel phase.

8. A method to synthesize an electrode for a lithium-carbon dioxide battery, comprising:
preparing a metal hydroxide precursor having a manganese-based transition metal oxide;
precipitating the metal hydroxide precursor onto a carbon cloth;
calcinating the metal hydroxide precursor onto the carbon cloth; and
forming a manganese-based transition metal electrode for a lithium-carbon dioxide battery.

9. The method of claim 8, wherein the metal hydroxide precursor has a chemical formula of AMn₂O₄, wherein A is selected from nickel, zinc, or cobalt.

10. The method of claim 8, wherein the metal hydroxide precursor is precipitated onto the carbon cloth using an electrodeposition method.

11. The method of claim 8, wherein calcinating the metal hydroxide comprises exposing the metal hydroxide precursor to a temperature above 400° C.

12. The method of claim 8, wherein the metal hydroxide precursor comprises Mn₂(OH)₄.

13. The method of claim 8, wherein preparing the metal hydroxide precursor comprises forming the metal hydroxide precursor by combining ANO₃ and Mn₂O₃.

14. The method of claim 8, wherein the electrode comprises a manganese-based transition metal electrocatalyst in the form of a nanosheet.

15. The method of claim 14, wherein the manganese-based transition metal electrocatalyst comprises a crystal structure comprising a spinel phase.

16. A lithium-carbon dioxide battery, comprising:
at least one electrode having an electrocatalyst supported by a carbon cloth; and
wherein the electrocatalyst includes a manganese-based transition metal oxide.

17. The lithium-carbon dioxide battery of claim 16, wherein the electrocatalyst has a nanostructure.

18. The lithium-carbon dioxide battery of claim 16, wherein the manganese-based transition metal oxide has a chemical formula of AMn₂O₄, in which A is selected from nickel, zinc, or cobalt.

19. The lithium-carbon dioxide battery of claim 16, wherein the electrocatalyst has a dimension of from about 1 nm to about 100 nm.

20. The lithium-carbon dioxide battery of claim 16, wherein the electrocatalyst is in the form of a nanosheet.
